(19) United States
(12) Patent Application Publication
(10) Pub. No.: US 2002/0106261 A1
(43) Pub. Date: Aug. 8, 2002

(54) Cilp for fastening a mounting member to an automobile body

(76) Inventor: Hideaki Nakanishi, Toyohashi-shi (JP)

Correspondence Address: Edward D. Murphy, TW199, The Black & Decker Corporation, 701 East Joppa Road, Towson, MD, 21286, US

(21) Appl. No.: 09/845,004

(22) Filed: Apr. 27, 2001

(30) Foreign Application Priority Data
Feb. 6, 2001 (JP) 2001-029324

(51) Int. Cl. F16B 19/00

(52) U.S. Cl. 411/508

(57) ABSTRACT

To provide a clip 38 which maintains a force for coupling a trim board 39 to a base member 41 of the body of an automobile over a wide range of thicknesses of the base member. The clip 38 has a head 42 adapted to be engaged with and connected to the trim board 39 and a leg 43 extending from the head 42 and adapted to be inserted into a mounting hole of a base member 41 to be fastened thereto. The leg 43 includes a suction cup shaped flange 49 adjacent to the head 42 and adapted to contact one of the surfaces of the base member 41 and a shank 50 extending from the flange 49. The shank 50 has a flexible engagement section 54 formed in a larger diameter at a position in the vicinity of the flange 49 but spaced from the flange by a distance greater than the thickness of the base member 41. The suction cup shaped flange 49 is formed with at least one radial slit 53 yielding a resiliency to allow the marginal region 51 of the flange to be deformed toward the head 42 while retaining a force for pressing the base member 41 in the axial direction of the leg 43. The flexible engagement section 54 of the shank 50 includes a first flexible engagement region 55 close to the flange 49 and a second flexible engagement region 57 remote from the flange 49. The second flexible engagement region 57 is formed with a larger diameter than that of the first flexible engagement region 55.

### BACKGROUND OF THE INVENTION

The present invention relates to an integrally molded plastic clip comprising a head adapted to engage with a component, such as trim boards of automobiles, and a leg extending from the head and adapted to be mountedly inserted into a mounting hole of a base member, such as automobile bodies, so as to fasten the component, such as trim boards, to the base member, such as automobile bodies.

As an integrally molded plastic clip for fastening a trim board to a base member of an automobile body, there has been known a clip having a shape as shown in FIGS. 1, 2 and 3. This clip 1 comprises a head 3 adapted to engage with the trim board 2, and a leg 6 extending from the head 3 and adapted to be mountedly inserted into a mounting hole of the base member or body 5. The leg 6 includes a suction-cup shaped flange 7 adjacent to the head 3 to contact the upper surface of the base member 5, and a shank 9 extending from the flange 7. The shank 9 has a flexible engagement section 10 formed in an enlarged diameter of the shank 9 at a position in the vicinity of the flange 7, but axially spaced from the flange 7 by a distance somewhat greater than the thickness of the base member 5. As shown in FIG. 2, the shank 9 is formed in an approximately sigmoidal, or “S” shape to provide a relatively large engagement area to the marginal region of the mounting hole of the base member 5 and a sufficient radial resiliency. As long as the thickness of the base member 5 lies in a certain range, the clip 1 may provide a simplified mounting operation, a stably maintained fastening performance after the mounting operation, and a convenient detachability. Thus, the conventional prior art has received wide acceptance.

The prior art clip having the sigmoid-section shank has advantageous capabilities of being readily inserted and retaining a high engaging force after inserted. This advantage may be enjoyed if the thickness of the base member lies in a limited range. However, if the thickness of the base member exceeds this limited range, the flexible engagement section 10 cannot reach the marginal region of the base member, resulting in an unstable engagement. A main reason for this is caused by the insufficient deformation of the suction-cup shaped flange 7. The size 11 designated on the left side of FIG. 3 shows a length between the lower surface of the flange 7 under no applied pressure to the flange 7 and the flexible engagement section 10. The size 13 designated on the right side of FIG. 3 shows a maximum length therebetween in the state that the marginal region of the flange 7 is pressed onto the base member and consequently deformed toward the head 3. The difference 14 therebetween is small and this proves that the thickness of the base member 5 in a limited range. In this respect, the conventional prior art clip needs to be improved in order to have desirable adaptability for use with base members of thicknesses greater than that shown at 14.

In addition to the clip shown in FIGS. 1, 2 and 3, other prior art clips are depicted in FIGS. 4 through 8. One example of a prior art clip discloses a panel fastener comprising a flange having an opened-umbrella shape, and a leg having an approximate sigmoid “S” shape in cross section at an engagement section. This type of fastener 15 is shown in FIGS. 4, 5 and 6. As is apparent from these figures, three-step engagement sections 18, 19 and 21 are formed in the leg 17. These engagement sections 18, 19 and 21 connect a second panel or trim board 25 with a first panel or base member 23 between the head or flange 22 of the fastener 15. This fastener 15 may cope with a wide range of thickness. Specifically, the first flexible engagement region 18 functions when the thickness “a” (FIG. 4) which is the total thickness of a first panel 23 and a second panel 25 is relatively thin, the flexible engagement section 19 functioning when the thickness “b” (FIG. 5) which is the total thickness of the first panel 23 and the second panel 25 is an intermediate thickness, and the third flexible engagement section 21 functioning when the thickness “c” (FIG. 6) which is the total thickness of the first panel 23 and the second panel 25 is relatively thick. However, the flange 22 is a rigid body having no flexibility. Thus, when each thickness “a”, “b”, “c” has some difference from each corresponding distance between the lower surface of the flange 22 and each engagement section 18, 19, 21, some undesirable axial movement or displacement can occur. Further, the engagement sections 18, 19 and 21 are engaged with the marginal region of a mounting hole of the first panel 23, and the second panel 25 is formed with a mounting hole having a larger diameter than that of the mounting hole of the first panel 23. That is, while the fastener 15 may cope with the variance of the thickness in two or more panels each having different sized mounting hole, it cannot cope with the variance of the thickness in a single panel or a plurality of panels each having a same size mountain hole. Thus, for fastening a component, such as trim boards, to a base member, this fastener 15 leaves something to be improved upon in order to have desirable adaptability for thickness variation of the base member.

Another prior art clip or panel fastener 26 is shown in FIGS. 7 and 8. The fastener 26 comprises a head or flange 29 adapted to engage with a first panel or trim board 27, and a leg 31 extending from the head 29 and mountedly inserted in a mounting hole of a second panel or base member 30 of an automobile. The leg 31 includes a flange 33 having a particular shape, and a wedge (V) shaped shank 34 extending downward from the flange 33. The shank 34 is formed with an engagement section 35 having a radial resiliency. The flange 33 is radially protruded from the downside of the head 29 to form a three-petal shape. Each petal section is protruded obliquely downward and has an axial resiliency. For coupling the first panel 27 with the second panel 30 by use of the fastener 26, the flange 33 is deformed inwardly in the radial direction of the leg 31 to allow the flange 33 to be aligned with the shank 35 (see FIG. 8(A)), and then inserted into a mounting hole of the first panel 27 with the leg 31 made as thin as possible. When the flange 33 is released and opened out, the first panel 27 is clipped between the head 29 and the flange 33 as shown in FIG. 8(B). In this state, when the leg 34 is inserted into the mounting hole of the second panel 30, the engagement section 35 engaged with the marginal region of the mounting hole of the second panel 30, and thereby the first panel is mounted to the second panel 30, as shown in FIG. 8(C). One feature of the prior art fastener 26 is that the flange 33 is formed in the shape having three petals to allow the flange 33 to be deformed relative to the shank 34 from which it is axially spaced. By virtue of this configuration, the first panel may be retained between the head 29 and the flange 33. However, the force of the flange 33 for retaining the second panel 30 is not very strong and this may result in undesirable axial displacement. Further, if a pressing force is applied upward to the lower end of the leg 34 in the state that the fastener 26 is inserting into the mounting hole of the second panel 30 as shown in FIG. 8(B), the fastener 26 may assume the state shown in FIG. 8(A) and undesirably come off. Thus, when the fastener 26 is mounted to the first panel 27 in advance to carry it to an automobile assembling plant in such a state, it is feared that the fastener 26 may drop off or accidentally be removed from the second panel 30. In addition, the fastener 26 cannot cope with variations in the thickness of the second panel 30. Thus, for fastening a component such as a trim board to a base member of an automobile, this fastener 15 also leaves something to be improved upon.

### SUMMARY OF THE PRESENT INVENTION

In view of the above problems of the conventional prior art clips, it is an object of the present invention to provide a clip capable of retaining a sufficient force for coupling a component, such as an interior trim board, to a base member of an automobile regardless of variation of, or significant difference in, the thickness of the base member. It is another object of the present invention to provide a clip that is simple to make, economical to produce and high reliable.

### BRIEF DESCRIPTION OF THE ACCOMPANYING DRAWINGS

With reference to the accompanying drawings, FIGS. 9 through 16 depict a preferred embodiment of the present invention, as will be described in greater detail hereinafter.

FIG. 1 is a front view of the prior art clip which shows the clip fastening an interior trim board to an automobile body;

FIG. 2 is a sectional view of the prior art clip taken along line A-A of FIG. 1;

FIG. 3 is a schematic diagram illustrating the limited range of deformation of a prior art clip of the type shown in FIG. 1;

FIG. 4 is a front view showing a thin plate coupled to a panel by one type of prior art fastener;

FIG. 5 is a front view showing an intermediate thickness plate coupled to a panel by the prior art fastener of FIG. 4;

FIG. 6 is a front view showing a relatively thick plate to a panel coupled by the prior art fastener of FIG. 4;

FIG. 7 is a front view of another type of prior art fastener;

FIG. 8 depicts the type of prior art fastener of FIG. 7 wherein FIG. 8(A) is a sectional view showing said fastener after being inserted into a first panel, FIG. 8(B) is a sectional view just before said fastener was inserted into a second panel, and FIG. 8(C) is a sectional view after the said fastener was inserted into the second panel;

FIG. 9 is a front view of a clip according to a preferred embodiment of the present invention;

FIG. 10 is a right side view of the clip of FIG. 9;

FIG. 11 is a bottom plan view of the clip of FIG. 9;

FIG. 12 is a sectional view of the clip taken along line B-B of FIG. 9;

FIG. 13 is a front view showing the relationship between undeformed and deformed flange portions and first and second flexible engagement regions of the clip of FIG. 9;

FIG. 14 is a front view of the clip of FIG. 9 being fastened to a relatively thin base member;

FIG. 15 is a front view of the clip of FIG. 9 being fastened to a base member having an intermediate thickness; and

FIG. 16 is a front view of the clip of FIG. 9 being fastened to a relatively thick base member.

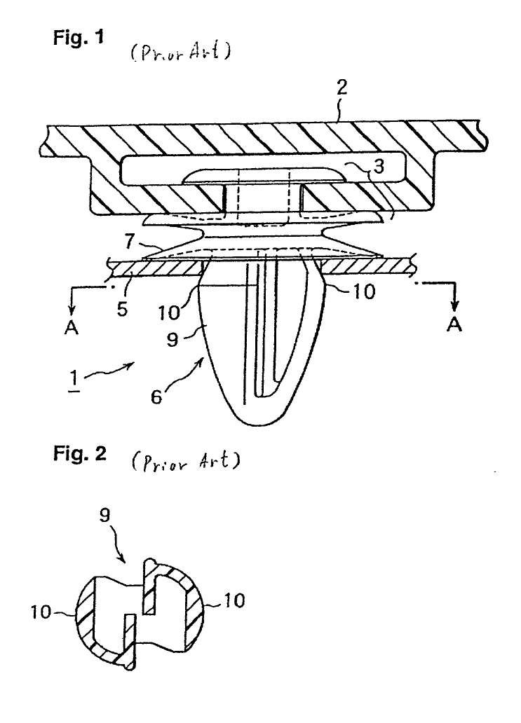

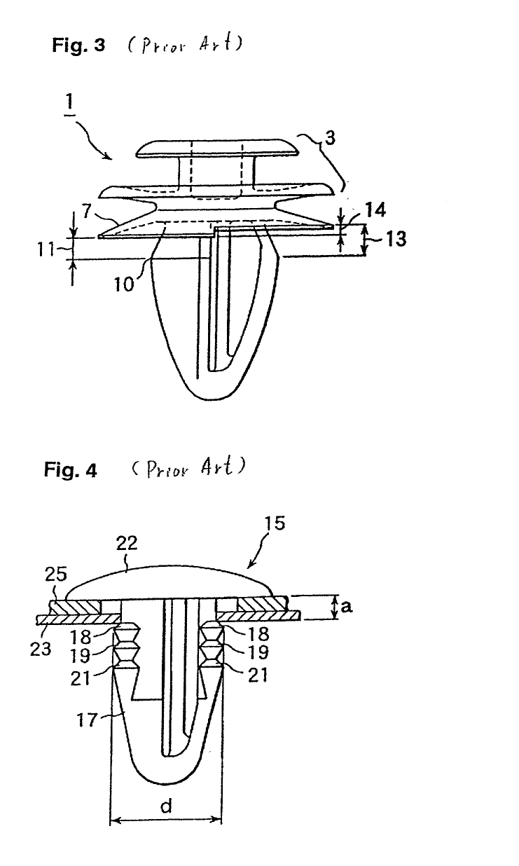

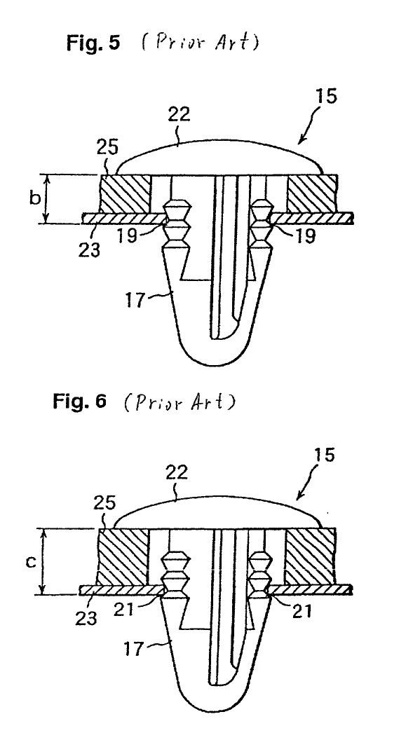

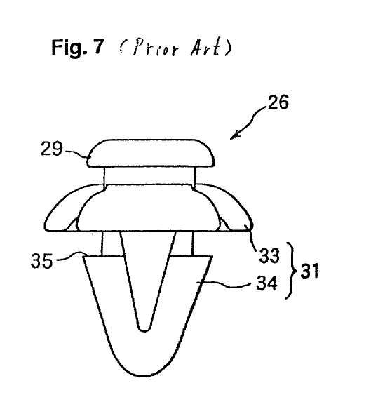

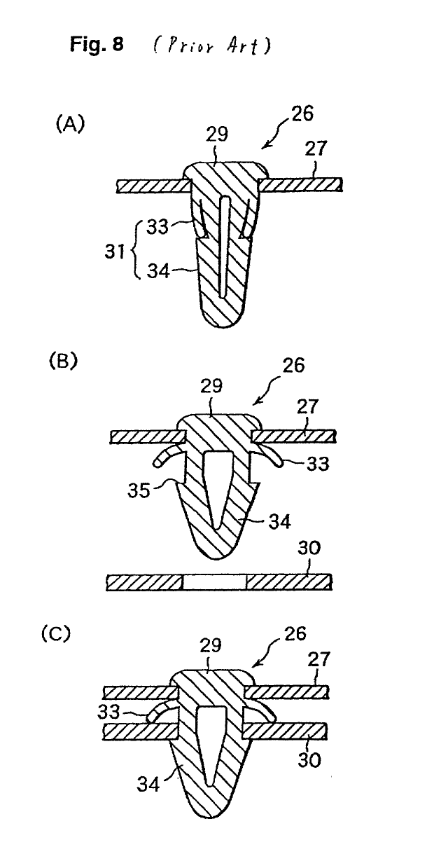

### DETAILED DESCRIPTION OF THE PREFERRED EMBODIMENT

An integrally molded plastic clip having a head adapted to engage a trim board, and a leg of the clip extending from the head adapted to be mountedly inserted into a mounting hole of a base member of an automobile wherein the leg includes a suction cup shaped flange adjacent to the head to contact one of the surfaces of the base member, and a shank extending from the flange, the shank having a flexible engagement section formed in a larger diameter region at a position in the vicinity of the flange but spaced from the flange by a distance greater than the thickness of the base member. The clip has the suction cup shaped flange formed with at least one radial slit that provides yielding resiliency to allow the marginal region of the flange to be deformed toward the head while retaining a force for pressing against the base member in the axial direction of the leg; and the flexible engagement section of the shank includes a first flexible engagement region close to the flange and a second flexible engagement region spaced from the flange a greater distance than the first flexible engagement region, wherein the second flexible engagement region is formed in a larger diameter than that of the first flexible engagement region. Thus, the specific slit formed in the suction cup shaped flange may provide a sufficiently enhanced deformation, which provides an improved adaptability for a wide range of the thickness of the base member. In addition, since the flexible engagement section includes the first and second flexible engagement regions and the second flexible engagement region is formed in a larger diameter than that of the first flexible engagement region, this clip may be mounted to the mounting hole of a single base member having a wide range of different thickness. This clip may also be mounted to a plurality of superposed base members each having a same sized mounting hole even if the superposed base members have a wide range of different thicknesses.

In the aforementioned clip, the shank of the leg, as shown, is formed in an approximately sigmoidal or “S” shape in the cross section of the flexible engagement section to provide a relatively large engagement area to the marginal region of the mounting hole and a sufficient radial resiliency. Also, the first and second flexible engagement regions of the shank have long circumferences in addition to their respective sigmoidal shape. Lastly, there is provided two slits in the radial direction of the flange.

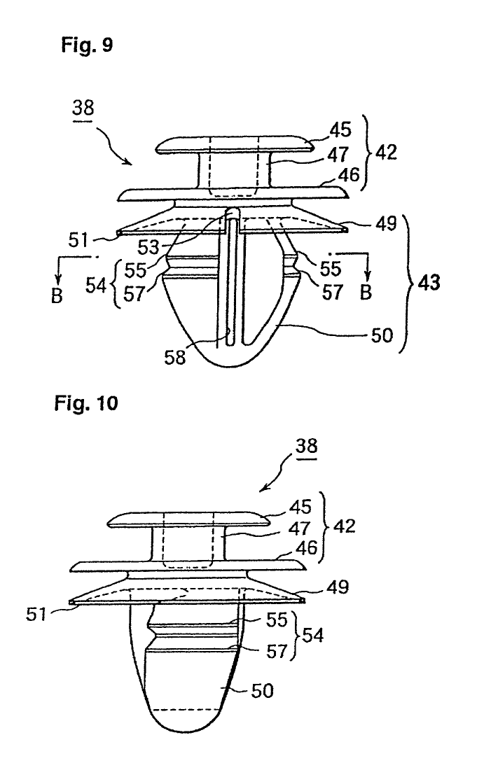

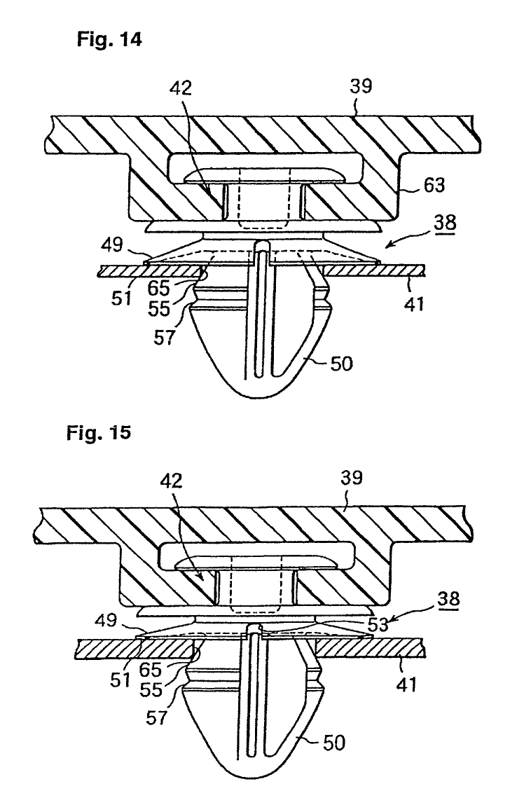

Turning now to the drawings, the preferred embodiment of the present invention is shown in FIGS. 9 through 16 wherein a clip 38 will be described in greater detail. In FIGS. 14 to 16, a trim board 39 is shown mounted to a base member 41 of an automobile by use of the clip 38.

In FIGS. 9 through 13, the clip 38 is an integrally molded plastic clip that will be used to mount the trim board to a base member of the body of the automobile. The clip 38 includes a head 42 adapted to engage the trim board and a leg 43 extending downward from the head 42 and adapted to be inserted into a mounting hole of the base member of the automobile and, thus, be mounted to the base member. The head 42 may have any shape adapted to engage with and retain the trim board. In the embodiment illustrated, the head 42 comprises a pair of rigid flanges 45 and 46, and a neck 47 connecting between the pair of flanges. The first upper rigid flange 45 is formed in a smaller diameter than that of the second lower rigid flange 46. The first flange 45 is first inserted into a large hole of a keyhole shaped mounting hole (not shown) formed in the trim board. After insertion, when the head 42 of the clip is slid to a small hole of the keyhole shaped mounting hole, the trim board will be clamped between the pair of flanges 45 and 46. Thus, the clip 38 will be engaged with and retain on the trim board. Any other suitable shape may be applied to the head 42 to retain the trim board. For example, the head 42 may have a flange for retaining an additional component on the panel, wherein the flange is positioned at a certain height (see U.S. Pat. No. 3,745,612) or the head 42 may have a suitable plate shape.

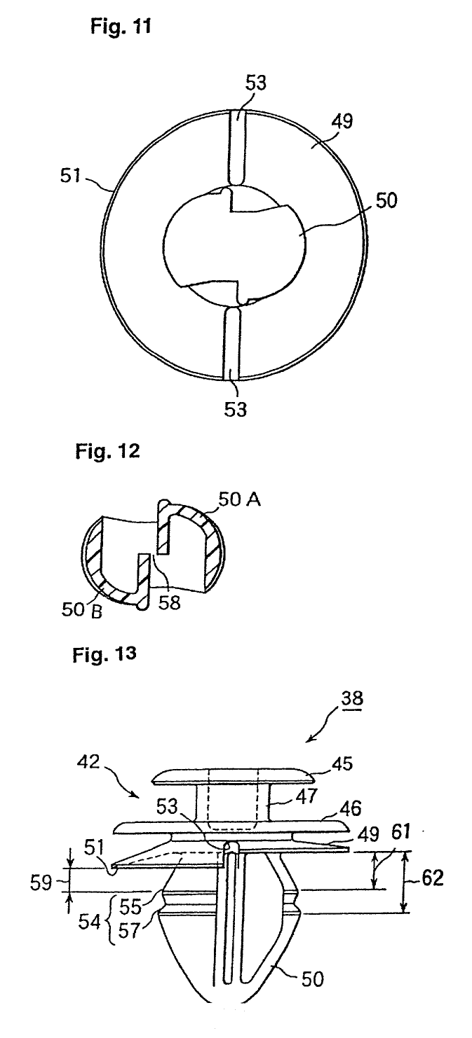

The leg 43 includes a suction cup shaped flange 49 adjacent to the second rigid flange 46 located on the underside of the head 42, and a shank 50 extending downward from the suction cup shaped flange 49. As is apparent from FIG. 11, the suction cup shaped flange 49 has a circular shape as a whole, and its marginal region 51 extends obliquely downward operably to contact and press the surfaces of the base member. As shown by the broken line in FIGS. 9 and 10, the thickness of the suction cup shaped flange 49 is thinned gradually in a radially outward direction which provides resiliency to allow the flange 49 to be deformed in the axial direction of the shank 50 (i.e., vertical direction of FIGS. 9 and 10). The suction cup shaped flange 49 is formed with slits 53 extending in the radial direction of the shank 50 to provide a resiliency to allow the marginal region 51 of the flange 49 to be deformed toward the head 42 while retaining or keeping a force for pressing the base member in the axial direction of the leg. Although a single slit 52 may be provided, two slits are provided in this embodiment to make a pair along the diametrical direction of the leg as shown in FIG. 11. These slits 53 may provide an increased axial deformation of the flange 49 toward the head 45. However, the width of the slit 53 is small enough so as not to greatly reduce the pressing force of the marginal region 51 of the flange 49 upon the base member.

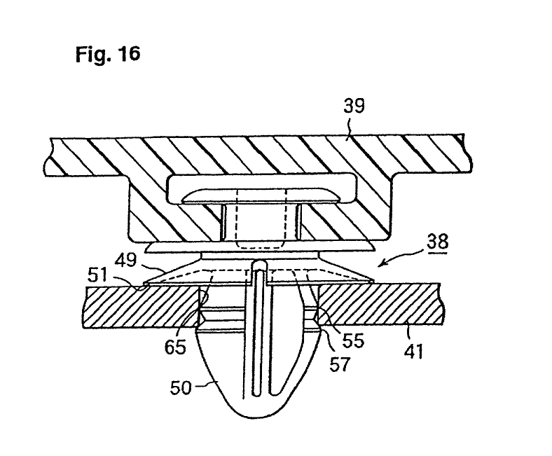

The shank 50 of the leg 43 includes a flexible engagement section 54 formed in a larger diameter portion of the shank 50 in the vicinity of the suction cup shaped flange 49 but spaced below the flange 49 by a distance greater than the thickness of the base member. The flexible engagement section includes a first flexible engagement region 55 close to the flange 49 and a second flexible engagement region 57 formed below region 55 and spaced further away from the flange 49. When the shank 50 has passed through the mounting hole of the base member, either the first (see FIGS. 14 and 15) or the first and second (see FIG. 16) flexible engagement regions 55, 57 engages with the marginal region of the mounting hole of the base member to mount the clip 38 onto the base member 41 in cooperation with the flange 49. The shank 50 is tapered radially inwardly of the flexible engagement section 54 to the lower end of the shank 50 so as to facilitate inserting the shank 50 into the mounting hole of the base member 41. As illustrated in FIG. 12 showing a cross section in the first flexible engagement region 55 of the flexible engagement section 54, the shank 50 is formed in an approximately sigmoidal or “S” shape in the cross section to provide a relatively large engagement area to the marginal region of the mounting hole and a sufficient radial resiliency. Particularly in this embodiment, as shown best in FIG. 9, the shank 50 is formed with a longitudinally extending slit 58 at the center of the shank to divide the shank 50 into two portions 50A and 50B (FIG. 12) which provides an increased radial resiliency.

In the flexible engagement section 54 of the shank 50, the second flexible engagement region 57 is formed in a larger diameter than that of the first flexible engagement region 55. Thus, when the base member 41 is thin (see FIG. 14), the first flexible engagement region 55 may reliably engage with the back surface of the base member 41 at its marginal region of the mounting hole. Further, in the case where the base member 41 is thicker (see FIG. 16), such that the first flexible engagement region 55 enters but cannot pass all the way through the mounting hole and only the second flexible engagement region 57 is successfully passed through, the second flexible engagement region 57 may reliably engage with the back surface of the base member 41 of the marginal region of the mounting hole because the second flexible engagement region 57 protrudes radially outward more than the first flexible engagement region 55. As described above, the flange 49 is formed with the slits 53 and the first and second flexible engagement regions 55 and 57 are also provided. Thus, this clip may be mounted to the mounting hole of a single base member 41 having a wide range of different thicknesses. This clip may also be mounted to a plurality of superposed base members, each having a same-sized mounting hole, even if the superposed base members have a wide range of different thicknesses as a whole. The size 59 designated on the left side of FIG. 13 shows a length between the lower surface of the marginal region of the flange 49 under no applied pressure to the flange 49 and the first flexible engagement region 55. This size 59 may be defined on the basis of the smallest thickness of the base member to be applied. The size 61 designated at the left hand on the right side of FIG. 13 shows a length between the first flexible engagement region 55 and the lower surface of the marginal region of the flange 49 in the state that the marginal region of the flange 49 is pressed onto the base member in a most largely deformed manner. This size 61 may be defined based on the medium thickness of the base member 41. The size 62 designated at the right hand on the right side of FIG. 13 shows a length between the second flexible engagement region 57 and the lower surface of the marginal region of the flange 49 in the state that the marginal region of the flange 49 is deformed the largest. This size 62 may be defined on the basis of the largest thickness of the base member 41. Thus, the clip may be applied to various base members 41 of automobiles having a wide range of thickness, from thin to medium, to thick.

FIGS. 14, 15 and 16 show the trim board 39 mounted to the base member 41 by use of the clip 38 configured as described above. In FIG. 14, the head may be engaged with and attached to a keyhole shaped mounting hole provided in a retaining section 63 of the trim board 39. The trim board 39 attached with the clip 38 is carried to the base member 41 and then the shank 50 of the leg 43 of the clip 38 is inserted in and connected to a mounting hole 65. Since the base member 41 of FIG. 14 has a relatively small thickness, when the suction cup shaped flange 49 contacts the surface of the base member 41, the first flexible engagement region 55 may pass through the mounting hole 65 of the marginal region 51 and the engagement surface of the first flexible engagement region 55 may engage the back surface of the base member 41. Thus, the clip 38 may be fastened to the base member 41 and the component 39 will be mounted to the base member 41 by the clip 38. Since the base member 41 has a relatively small thickness, the suction cup shaped flange will be deformed by only a small amount.

In FIG. 15, the base member 41 has a medium thickness which is slightly larger than the thickness shown in FIG. 14. When the shank 50 is inserted into the mounting hole 65 and a sufficient force is applied to the clip 38 downward, the suction cup shaped flange 49, having the slits 53, is deformed toward the head 42 and, thereby, the first flexible engagement region 55 may pass through the mounting hole 65. Then, the engagement surface of the first flexible engagement region 55 may engage with the back surface of the base member 41. Thus, the clip 38 may be fastened to the base member 41 and the trim board 39 may be coupled with the base member 41. In FIG. 16, the base member 41 has a substantially large thickness. When the shank 50 is inserted into the mounting hole 65 and a sufficient force is applied to the clip 38 downward, the suction cup shaped flange 49, having the slits 53, is deformed toward the head 42. While the first flexible engagement region 55 may not pass through the mounting hole 65, the second flexible engagement region 57 will pass through the mounting hole 65. Then, the engagement surface of the second flexible engagement region 57 will be engaged with the back surface of the base member 41. Thus, the clip 38 may be fastened to the base member 41 and the trim board 39 may be coupled with the base member 41. As described above, the clip 38 may be mounted onto a single base member 41 which has a wide range of thickness that is from the thin base member shown in FIG. 14 to the thick base member shown in FIG. 16. It will be apparent that this clip 38 may also be mounted to a plurality of superposed base members 41, each having a same-sized mounting hole even if the superposed base members 41 have a wide range of different thickness. The flexible engagement sections may be formed into a two step or more, for example a three step, flexible engagement section (not shown). In case of the three step configuration, a third flexible engagement region may be located below the second flexible engagement region to be further spaced from and axially downwardly of the suction cup shaped flange. The third flexible engagement region (not shown) will be formed in a larger diameter than that of the second flexible engagement region.

According to the clip 38 of the present invention, the specific slit(s) formed in the suction cup shaped flange may have a sufficiently enhanced deformation which provides an improved adaptability for a wide range of the thickness of the base member. In addition, since the flexible engagement section includes the first and second flexible engagement regions and the second flexible engagement region is formed in a larger diameter than that of the first flexible engagement region, the clip 38 may be mounted to the mounting hole of a single base member having a wide range of different thickness. The clip 38 may also be mounted to a plurality of superposed base members 41 (not shown), each having a same sized mounting hole even if the superposed base members 41 have a wide range of different thickness. Thus, the clip 38 may be provided as an integrally molded simplified structure and may contribute to a sufficiently reduced cost and enhanced adaptability.

In general, the above identified embodiment is not to be construed as limited the breadth of the present invention. It is understood that the present invention may be modified or have other alternative constructions that are apparent from and within the scope of the present invention as defined in the appended claims.

What is claimed is:

1. An integrally molded plastic clip to connect a trim board to a base member of an automobile said clip comprising
a. a head of the clip adapted to engage the trim board;
b. a leg of the clip extending from said head and adapted to be inserted into a mounting hole of the base member;
c. the leg includes a suction cup shaped flange adjacent to said head to contact a surface of said base member;
d. a shank extending from the flange of the leg, with the shank having a flexible engagement section formed in a larger diameter section of the leg at a position in the vicinity of said flange but apart from said flange by a distance greater than the thickness of said base member, wherein the suction cup shaped flange is formed with at least one radial slit yielding a resiliency to allow the marginal region of said flange to be deformed toward said head while retaining a force for pressing the base member in the axial direction of the leg; and
e. the flexible engagement section of the shank including a first flexible engagement region close to the flange and a second flexible engagement region spaced from the flange a distance more than the length of the first flexible engagement region, wherein the second flexible engagement region is formed in a larger diameter section of the leg than that of the first flexible engagement region.

2. The combination claimed in claim 1 wherein:
a. the shank of the leg has an approximately sigmoidal shape in the cross section of the flexible engagement section to provide a relatively large engagement area to the marginal region of said mounting hole and a sufficient radial resiliency.

3. The combination claimed in claim 2 wherein:
a. the first and second flexible engagement regions are formed in the circumferential direction to define the sigmoidal shape of the shank.

4. The combination claimed in claim 3 wherein:
a. two slits are formed along a diameter of the flange.

5. The combination claimed in claim 4 wherein:
a. the flexible engagement section includes a third flexible engagement region located at a position spaced from the flange more than the second flexible engagement region, wherein said third flexible engagement region is formed in a larger diameter section of the shank than that of the second flexible engagement region.
